(19) United States
(12) Patent Application Publication
(10) Pub. No.: US 2026/0197873 A1
(43) Pub. Date: Jul. 9, 2026

(54) CONFIGURING RANDOM ACCESS CHANNEL (RACH) OCCASION (RO) INDICATIONS

(71) Applicant: Lenovo (United States) Inc., Morrisville, NC (US)

(72) Inventor: Khaled Nafez Rauf ARDAH, Ilmenau (DE)

(21) Appl. No.: 19/009,618

(22) Filed: Jan. 3, 2025

(51) Int. Cl. H04W 74/0833; H04L 5/14

(52) U.S. Cl. CPC H04W 74/0833; H04L 5/14

(57) ABSTRACT

Various aspects of the present disclosure relate to a method for determining new random access channel (RACH) occasions (ROs) for use during random access procedures. For example, a network node (e.g., a base station) may configure a user equipment (UE) to derive a physical RACH (PRACH) configuration by combining a subframe or slot number one or more PRACH configuration indexes and transmit a preamble during random access via an RO that is based on the PRACH configuration (e.g., a “new” or derived PRACH configuration).

### TECHNICAL FIELD

The present disclosure relates to wireless communications, and more specifically to configuring random access channel (RACH) occasion (RO) indications for random access (RA) procedures.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Random access (RA) establishes connections between a user communication device and a network communication device, such as a base station. In time division duplexing (TDD) systems, where resources may be split between uplink (UL) resources and downlink (DL) resources in a time domain, a user communication device can utilize configured time-frequency resource occasions, or ROs, to transmit a preamble and initiate an RA procedure.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable the configuration of ROs, such as new or additional RO configurations within a UL subband for subband full duplex (SBFD)-aware UEs.

A UE for wireless communication is described. The UE may be configured to, capable of, or operable to perform one or more operations as described herein. For example, the UE may comprise at least one memory and at least one processor coupled with the at least one memory and configured to cause the UE to receive a RACH configuration message that indicates one or more physical RACH (PRACH) configuration indexes, determine a PRACH configuration by combining a subframe or slot number from the one or more PRACH configuration indexes, and transmit a PRACH preamble on an RO that is selected from the determined PRACH configuration.

A processor for wireless communication is described. The processor may be configured to, capable of, or operable to perform one or more operations as described herein. For example, the processor may comprise at least one controller coupled with at least one memory and configured to cause the processor to receive a RACH configuration message that indicates one or more PRACH configuration indexes, determine a PRACH configuration by combining a subframe or slot number from the one or more PRACH configuration indexes, and transmit a PRACH preamble on an RO that is selected from the determined PRACH configuration.

A method performed or performable by a UE is described. The method may comprise receiving a RACH configuration message that indicates one or more PRACH configuration indexes, determining a PRACH configuration by combining a subframe or slot number from the one or more PRACH configuration indexes, and transmitting a PRACH preamble on an RO that is selected from the determined PRACH configuration.

In some implementations of the UE, processor, and method described herein, the one or more PRACH configuration indexes are associated with a symbol type, including an SBFD symbols type and a non-SBFD symbols type.

In some implementations of the UE, processor, and method described herein, the RACH configuration message indicates at least one PRACH configuration index for each symbol type, and wherein the UE, processor, and method may further be configured to, capable of, performed, performable, or operable to receive an indication to utilize a PRACH configuration index of a first symbol type when determining a PRACH configuration for a second symbol type.

In some implementations of the UE, processor, and method described herein, the UE, processor, and method may further be configured to, capable of, performed, performable, or operable to derive one or more values of the determined PRACH configuration by comparing values of the one or more PRACH configuration indexes.

In some implementations of the UE, processor, and method described herein, the one or more PRACH configuration indexes includes a first PRACH configuration index that identifies a group of PRACH configurations separately indexed within a table and a second PRACH configuration index indicated from the group of PRACH configurations.

In some implementations of the UE, processor, and method described herein, the UE, processor, and method may further be configured to, capable of, performed, performable, or operable to cause the UE to determine the PRACH configuration by applying a subframe circular shift or a slot circular shift to a subframe or slot number of a PRACH configuration indicated from the one or more PRACH configuration indexes.

In some implementations of the UE, processor, and method described herein, the applied subframe circular shift or slot circular shift is fixed for each frequency range.

In some implementations of the UE, processor, and method described herein, the RACH configuration message comprises a bitmap that indicates subframes or slot numbers of a PRACH configuration index of the one or more PRACH configuration indexes.

In some implementations of the UE, processor, and method described herein, the bitmap is formed as a Kronecker product of multiple parts of the bitmap, and wherein each part of the multiple parts indicates a group of subframes or slot numbers.

A network entity for wireless communication is described. The network entity may be configured to, capable of, or operable to perform one or more operations as described herein. For example, the network entity may comprise at least one memory and at least one processor coupled with the at least one memory and configured to cause the network entity to generate a RACH configuration message that indicates two or more PRACH configuration indexes and transmit the RACH configuration message to a UE.

A method performed or performable by a network entity is described. The method may comprise generating a RACH configuration message that indicates two or more PRACH configuration indexes and transmitting the RACH configuration message to a UE.

In some implementations of the network entity and method described herein, the network entity and method may further be configured to, capable of, performed, performable, or operable to cause the network entity to receive a PRACH preamble on an RO associated with a PRACH configuration derived from the two or more RACH configuration indexes.

In some implementations of the network entity and method described herein, the network entity and method may further be configured to, capable of, performed, performable, or operable to cause the network entity to transmit the RACH configuration message via system information block type 1 (SIB1) signaling.

In some implementations of the network entity and method described herein, the network entity and method may further be configured to, capable of, performed, performable, or operable to cause the network entity to transmit the RACH configuration message via radio resource control (RRC) signaling or downlink control information (DCI) signaling.

In some implementations of the network entity and method described herein, the RACH configuration message indicates at least one PRACH configuration index for each symbol type.

In some implementations of the network entity and method described herein, the RACH configuration message comprises a bitmap that indicates subframes or slot numbers of a PRACH configuration index of the one or more PRACH configuration indexes.

In some implementations of the network entity and method described herein, the bitmap is formed a Kronecker product of multiple parts of the bitmap, and wherein each part of the multiple parts indicates a group of subframes or slot numbers.

In some implementations of the network entity and method described herein, the one or more PRACH configuration indexes are for a symbol type and include SBFD symbols and non-SBFD symbols.

In some implementations of the network entity and method described herein, the network entity and method may further be configured to, capable of, performed, performable, or operable to cause the network entity to transmit a message that activates PRACH configuration indicated by the two or more PRACH configuration indexes.

### BRIEF DESCRIPTION OF THE DRAWINGS

FIG. 1 illustrates an example of a wireless communications system in accordance with aspects of the present disclosure.

FIG. 2 illustrates example PRACH configuration indexes in accordance with aspects of the present disclosure.

FIG. 3 illustrates example communications between a UE and a base station in accordance with aspects of the present disclosure.

FIG. 4A-4B illustrate example RACH configurations in accordance with aspects of the present disclosure.

FIG. 5 illustrates an example mapping of a bitmap for a RACH configuration message in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In some wireless communication systems, user communication devices, such as UEs, perform random access procedures when establishing (or re-establishing) connections with the network. The wireless communications systems may utilize SBFD operations for RACH procedures, such as by enabling the RACH procedures to occur during or using SBFD symbols. Thus, during the RACH procedures, the UEs may transmit uplink UL signals in a sub-band on downlink DL symbols or transmit DL signals in a sub-band on UL symbols.

However, ROs are generally configured on UL resources (e.g., slots). However, RA procedures might suffer various drawbacks (e.g., from long latency and short coverage) when a configured TDD UL-DL pattern has few UL slots. Thus, RA may utilize SBFD UL subband resources to reduce latency and increase coverage.

To utilize the SBFD resources, ROs are to be configured on the UL subband. Two configuration options have been established. Following option 1, a single RACH configuration index is provided for both SBFD symbols and non-SBFD symbols, where the ROs within the UL subband in SBFD symbols may be valid for SBFD-aware UEs (e.g., UEs capable of performing SBFD). Following option 2, two separate RACH configurations are provided, including a legacy RACH configuration for non-SBFD symbols and an additional RACH configuration for SBFD symbols, where the ROs within the UL subband in SBFD symbols, configured by the additional RACH configuration, may be valid for SBFD-aware UEs. Both options employ random access configurations tables for unpaired spectrum.

However, existing random access configuration tables have been designed or configured based on only using UL slots, and the number of valid ROs within the UL subband may be limited for certain configurations, constraining, or minimizing, the benefits of enabling RA on the UL subband.

The technology described herein introduces new or additional RO configurations, such as new or additional configurations for ROs within the UL subband for SBFD-aware UEs. For example, newly configured ROs may be based on the merging of two or more PRACH configurations, such as PRACH configurations that are combined to form a new PRACH configuration. In doing so, a network may reduce latency and increase coverage by providing UEs with new or additional ROs when performing random access procedures, among other benefits.

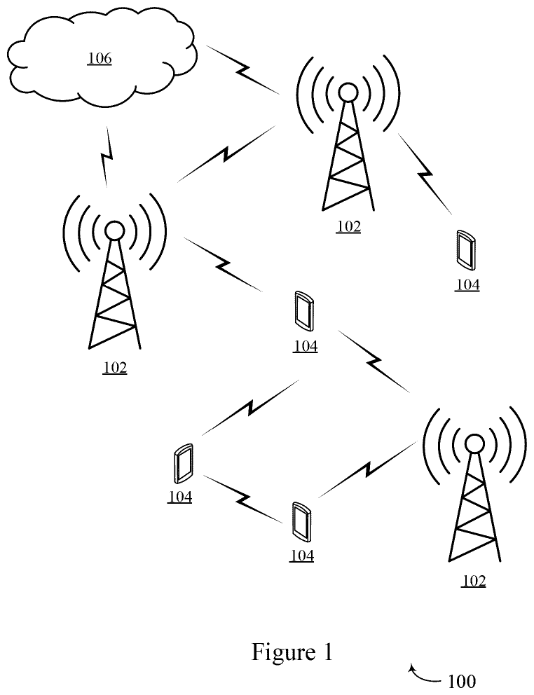

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a UE, such as the UE 104, may be configured to utilize ROs (e.g., when transmitting preambles) that are based on, or selected from, PRACH configurations determined from combinations of time resources (e.g., subframes, slot numbers, and so on) from PRACH configuration indexes.

Table 1 presents, for example, random access configurations for FR1 and unpaired spectrum:

TABLE 1

| | | | | | | | Nₜ^{RA, slot}, | |
|---|---|---|---|---|---|---|---|---|
| | | | | | | | number | |
| | | | | | | | of time- | |
| | | | | | | Number | domain | |
| | | | | | | of | PRACH | |
| | | | | | | PRACH | occasions | |
| PRACH | | | | | | slots | within a | N_{dur}^{RA}, |
| Configuration | Preamble | n_{f} mod x = y | | Subframe | Starting | within a | PRACH | PRACH |
| Index | format | x | y | number | symbol | subframe | slot | duration |
| . . . | . . . | . . . | . . . | . . . | . . . | . . . | . . . | . . . |
| 69 | A1 | 4 | 1 | 9 | 0 | 1 | 6 | 2 |
| 70 | A1 | 2 | 1 | 9 | 0 | 1 | 6 | 2 |
| . . . | . . . | . . . | . . . | . . . | . . . | . . . | . . . | . . . |
| 78 | A1 | 1 | 0 | 9 | 7 | 1 | 3 | 2 |
| 79 | A1 | 1 | 0 | 9 | 0 | 1 | 6 | 2 |
| . . . | . . . | . . . | . . . | . . . | . . . | . . . | . . . | . . . |
| 83 | A1 | 1 | 0 | 3, 4, 8, 9 | 0 | 1 | 6 | 2 |
| 84 | A1 | 1 | 0 | 3, 4, 8, 9 | 0 | 2 | 6 | 2 |
| . . . | . . . | . . . | . . . | . . . | . . . | . . . | . . . | . . . |
| 96 | A2 | 1 | 0 | 2 | 0 | 1 | 3 | 4 |
| 97 | A2 | 1 | 0 | 7 | 0 | 1 | 3 | 4 |
| . . . | . . . | . . . | . . . | . . . | . . . | . . . | . . . | . . . |
| 102 | A2 | 1 | 0 | 2, 7 | 0 | 1 | 3 | 4 |
| . . . | . . . | . . . | . . . | . . . | . . . | . . . | . . . | . . . |

As shown in the table, for a defined preamble format, every two PRACH configurations differ in at least one entry, and each configuration provides a different number of time-domain ROs using of several methods, such as periodicity, subframe numbers, a number of PRACH slots within a subframe, and a number of time-domain PRACH occasions within a PRACH slot.

For example, using periodicity, a PRACH configuration #70 configures 12 ROs within a 4-frame period compared to PRACH configuration #69, which configures 6 ROs (four frames since x=4). Thus, reducing the periodicity of a PRACH configuration increases the number of ROs or a ROs density in the time domain.

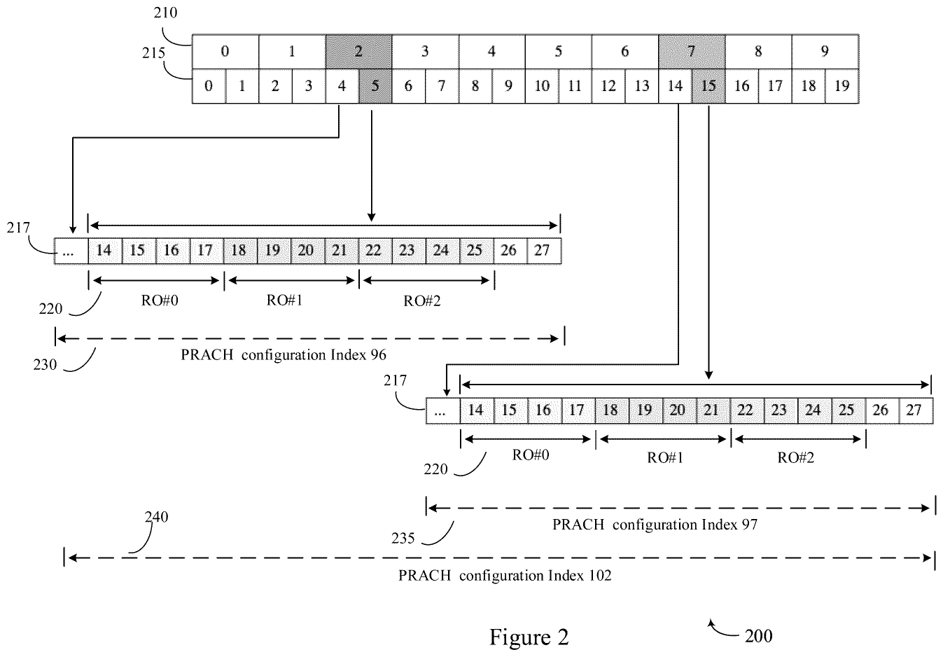

As another example, using subframe numbers, PRACH configurations #96 and #97 each configure 3 ROs within a one frame period (one frame since x=1). However, PRACH configuration #102 configures 6 ROs within one frame period by combining both PRACH configurations #96 and #97. FIG. 2 illustrates example PRACH configuration indexes 200 in accordance with aspects of the present disclosure.

As shown, PRACH configuration indexes can be mapped to time resources, including subframes 210 (e.g., slot# in 15 kHz SCS) and slots 215 (e.g., slot# in 30 kHz SCS). A first PRACH configuration index 230 (e.g., index 96) includes multiple symbols 217 (e.g., in 30 kHz SCS), associated with different ROs 220 (e.g., RO #0, RO #1, RO #2). A second PRACH configuration index 235 (e.g., index 97) includes multiple symbols 217 (e.g., in 30 kHz SCS), associated with different ROs 220 (e.g., RO #0, RO #1, RO #2). A third PRACH configuration index 240 (e.g., index 102) is a combination of the index 96 and the index 97. Thus, as shown, increasing the subframe numbers for a PRACH configuration increases the number of ROs.

As another example, using the number of PRACH slots within a subframe, PRACH configuration #84 configures 4×2×6=48 ROs within one frame period as compared to PRACH configuration #83, which configures 4×1×6=24 ROs within one frame period. Thus, increasing a number of PRACH slots within a subframe increases the number of ROs.

As another example, using a number of time-domain PRACH occasions within a PRACH slot, PRACH configuration #79 configures 6 ROs within one frame period as compared to PRACH configuration #78, which configures 3 ROs within one frame period. Thus, the number of ROs can be increased by increasing the number of time-domain PRACH occasions within a PRACH slot (while the above numbers of ROs represent a maximum number of ROs that a PRACH configuration can provide, an actual number (e.g., a number of valid ROs that a UE can use is subject to predefined “ROs validation rules” such as an RO falling within an UL slot or within an UL subband of usable RBs).

Thus, as provided in the examples, two PRACH configurations may be different by only one entry, and one PRACH configuration may be newly configured by changing an entry to another PRACH configuration. Further, one PRACH configuration may be configured by combining or more merging multiple (e.g., two or more) PRACH configurations (e.g., the index #102 is a combination of the index #96 and the index #97). Thus, the network may configure addition ROs by indicating and merging two or more PRACH configurations to implicitly configure a PRACH configuration (e.g., a new PRACH configuration).

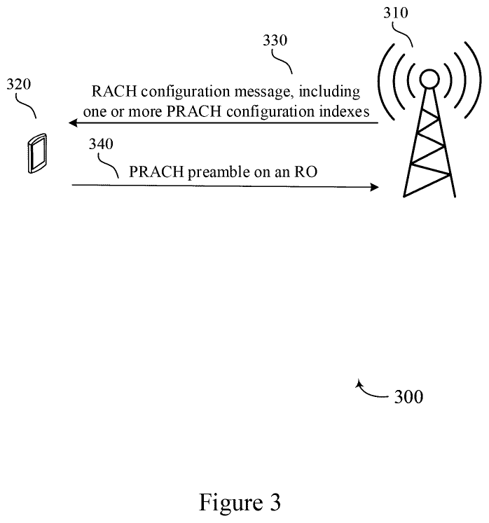

FIG. 3 illustrates example communications 300 between a UE and a base station in accordance with aspects of the present disclosure. For example, a wireless cell may include a base station 310 (e.g., a serving base station or network node) and a UE 320, where the UE 320 transmits to the base station over an uplink channel and the base station 310 transmits to the UE 320 over a downlink channel. As described herein, the UE 320 may be configured with an SBFD resource configuration. Via SBFD, a sub-band in a bandwidth of a wireless link or channel is configured to perform communication in a direction that is different from the direction of communication in the rest of the bandwidth. For example, a UL sub-band on a DL symbol refers to a sub-band within the DL bandwidth that may be used for UL communications.

The base station 310 may configure the UE 320 with new or additional PRACH configurations, as described herein. For example, the base station 310 may transmit a RACH configuration message 330, which indicates one or more PRACH configuration indexes (e.g., the indexes described herein). The base station 310 may transmit the RACH configuration message 330 via SIB1 signaling and/or via a dedicated RRC/DCI signaling. The RACH configuration message 330 may indicates PRACH configuration indexes (e.g., multiple indexes) from a configured table (e.g., Table 6.3.3.2-3 for FR1) and unpaired spectrum.

In some cases, the PRACH configuration indexes are intended or associated with a specific symbol/slot type (e.g., for SBFD symbols/slots or non-SBFD symbols/slots). The RACH configuration message 330 may explicitly indicate the symbol/slot type. In some cases, the base station 310 may transmit an independent (e.g., second) configuration message, such as an SBFD time-frequency configuration message.

The UE 320 receives the RACH configuration message 330 and determines a PRACH configuration by combining a subframe or slot number from the PRACH configuration indexes.

The UE 320 may receive one or more PRACH configuration indexes separately for each symbol/slot type and receive an indication to use the PRACH configuration indexes when deriving or determining the ROs of the other symbol/slot type. When the base station 310 does not signal the indication message, the UE 320 may utilize one or more PRACH configuration indexes of one symbol/slot type when deriving the ROs of the other symbol/slot type.

For example, the base station 310 may indicate to the UE 320 to utilize PRACH configurations #n for SBFD symbols/slots and PRACH configurations #m for non-SBFD symbols/slots and/or may indicate to the UE 320 to utilize the PRACH configurations #m in addition to the PRACH configurations #n when deriving the ROs for SBFD symbols/slots, as described herein.

In some cases, the RACH configuration message 330 may indicate one or more PRACH configuration indexes as being inactive, and the base station 310 may transmit (e.g., via RRC, MAC-CE, and/or DCI signaling) an activation/deactivation message that activates or deactivates the inactive PRACH configurations.

In some embodiments, as described herein, the UE 320 utilizes two or more PRACH configurations to derive or determine a PRACH configuration (e.g., a new PRACH configuration). For example, the UE 320 may derive the new PRACH configuration by combining the subframe/slot numbers of the indicated PRACH configurations, while remaining parameters of the new PRACH configuration are used following a reference PRACH configuration (e.g., the first indicated PRACH configuration of the two or more PRACH configurations, as shown in Table 2. In some cases, the reference PRACH configuration index may be indicated within the RACH configuration message 330.

In some embodiments, one or more entries of the new PRACH configuration, not including a preamble format, may be updated by comparing the different values of all indicated PRACH configurations (e.g., the value of the new PRACH configuration is updated using the minimum/maximum value among the indicated ones).

TABLE 2

| | | | | | | | Nₜ^{RA, slot}, | |
|---|---|---|---|---|---|---|---|---|
| | | | | | | | number | |
| | | | | | | | of time- | |
| | | | | | | Number | domain | |
| | | | | | | of | PRACH | |
| | | | | | | PRACH | occasions | |
| PRACH | | | | | | slots | within a | N_{dur}^{RA}, |
| Configuration | Preamble | n_{f} mod x = y | | Subframe | Starting | within a | PRACH | PRACH |
| Index | format | x | y | number | symbol | subframe | slot | duration |
| 102 | A2 | 1 | 0 | 2, 7 | 0 | 1 | 3 | 4 |
| 107 | A2 | 1 | 0 | 3, 4, 8, 9 | 0 | 2 | 3 | 4 |
| New | A2 | 1 | 0 | 2, 3, 4, 7, 8, 9 | 0 | 1 | 3 | 4 |

The UE 320 may then transmit a PRACH preamble 340 on an RO that is selected from the determined PRACH configuration. For example, the UE 320 may transmit the PRACH preamble 340 during a random access procedure.

In some embodiments, the UE 320 may utilize a first (or a reference) indicated PRACH configuration to identify a group of PRACH configurations within a defined/configured table that are indexed separately, and the other PRACH configurations of multiple PRACH configurations are indicated from the identified group. Via such indications, the base station 320 may reduce network overhead due to transmitting indications of all PRACH configurations.

In some cases, a PRACH configurations group may comprise some or all PRACH configurations of a preamble format. For example, the PRACH configurations of the preamble format A1 in Table 1 are from PRACH configuration #67 to PRACH configuration #86 (e.g., 20 consecutive PRACH configurations), and represent a PRACH configuration group for the preamble format A1. Therefore, when the RACH configuration message 330 indicates, for example, two RACH configurations, the first PRACH configuration index is indicated as a legacy index to fall between 0 and 262 (e.g., where 262 is a maximum PRACH configuration index), while the second PRACH configuration index is indicated to fall between 0 and 19, where the PRACH configuration #n indicates an nth PRACH configuration within the indicated PRACH configuration group by the first PRACH configuration index, as shown in Table 3.

TABLE 3

| | | | | | | | | Nₜ^{RA, slot}, | |
|---|---|---|---|---|---|---|---|---|---|
| | | | | | | | | number | |
| | | | | | | | | of time- | |
| | | | | | | | Number | domain | |
| PRACH | | | | | | | of | PRACH | |
| Configuration | | | | | | | PRACH | occasions | |
| group of A1 | PRACH | | | | | | slots | within a | N_{dur}^{RA}, |
| Preamble | Configuration | Preamble | n_{f} mod x = y | | Subframe | Starting | within a | PRACH | PRACH |
| format | Index | format | x | y | number | symbol | subframe | slot | duration |
| . . . | . . . | . . . | . . . | . . . | . . . | . . . | . . . | . . . | . . . |
| 0 | 67 | A1 | 16 | 1 | 9 | 0 | 2 | 6 | 2 |
| 1 | 68 | A1 | 8 | 1 | 9 | 0 | 2 | 6 | 2 |
| 2 | 69 | A1 | 4 | 1 | 9 | 0 | 1 | 6 | 2 |
| 3 | 70 | A1 | 2 | 1 | 9 | 0 | 1 | 6 | 2 |
| 4 | 71 | A1 | 2 | 1 | 4, 9 | 7 | 1 | 3 | 2 |
| 5 | 72 | A1 | 2 | 1 | 7, 9 | 7 | 1 | 3 | 2 |
| 6 | 73 | A1 | 2 | 1 | 7, 9 | 0 | 1 | 6 | 2 |
| 7 | 74 | A1 | 2 | 1 | 8, 9 | 0 | 2 | 6 | 2 |
| 8 | 75 | A1 | 2 | 1 | 4, 9 | 0 | 2 | 6 | 2 |
| 9 | 76 | A1 | 2 | 1 | 2, 3, 4, 7, 8, 9 | 0 | 1 | 6 | 2 |
| 10 | 77 | A1 | 1 | 0 | 9 | 0 | 2 | 6 | 2 |
| 11 | 78 | A1 | 1 | 0 | 9 | 7 | 1 | 3 | 2 |
| 12 | 79 | A1 | 1 | 0 | 9 | 0 | 1 | 6 | 2 |
| 13 | 80 | A1 | 1 | 0 | 8, 9 | 0 | 2 | 6 | 2 |
| 14 | 81 | A1 | 1 | 0 | 4, 9 | 0 | 1 | 6 | 2 |
| 15 | 82 | A1 | 1 | 0 | 7, 9 | 7 | 1 | 3 | 2 |
| 16 | 83 | A1 | 1 | 0 | 3, 4, 8, 9 | 0 | 1 | 6 | 2 |
| 17 | 84 | A1 | 1 | 0 | 3, 4, 8, 9 | 0 | 2 | 6 | 2 |
| 18 | 85 | A1 | 1 | 0 | 1, 3, 5, 7, 9 | 0 | 1 | 6 | 2 |
| 19 | 86 | A1 | 1 | 0 | 0, 1, 2, 3, 4, 5, | 7 | 1 | 3 | 2 |
| | | | | | 6, 7, 8, 9 | | | | |
| . . . | . . . | . . . | . . . | . . . | . . . | . . . | . . . | . . . | . . . |

In some embodiments, the UE 320 determines a subframe/slot number of a new RACH configuration by applying a shift (e.g., a constant circular shift) to the subframe/slot number of an indicated PRACH configuration. For example, the constant may be determined implicitly, based, for example, on a frequency range (e.g., SubframeShift=9 for FR1, and SlotShift=39 for FR2), as shown in Table 4.

TABLE 4

| | | | | | | | Nₜ^{RA, slot}, | |
|---|---|---|---|---|---|---|---|---|
| | | | | | | | number | |
| | | | | | | | of time- | |
| | | | | | | Number | domain | |
| | | | | | | of | PRACH | |
| | | | | | | PRACH | occasions | |
| PRACH | | | | | | slots | within a | N_{dur}^{RA} |
| Configuration | Preamble | n_{f} mod x = y | | Subframe | Starting | within a | PRACH | PRACH |
| Index | format | x | y | number | symbol | subframe | slot | duration |
| 71 | A1 | 2 | 1 | 4, 9 | 7 | 1 | 3 | 2 |
| “New” 71 | A1 | 2 | 1 | 0, 5 | 7 | 1 | 3 | 2 |

As shown in Table 4, the UE 320 is indicated to use RACH configuration #71 from Table 1 for FR1 and unpaired spectrum. The UE 320 determines that an associated subframe number set is {4, 9}. Using the preconfigured SubframeShift value=9, the UE 320 derives a new RACH configuration, where the associated subframe number set is determined as New Subframe number=SubframeShift−{Subframe number}=9−{4, 9}={5,0}.

In some embodiments, the UE 320 may receive an indication within the RACH configuration message 330 to apply or not apply the constant circular shift to the subframe/slot number. For example, when the UE 320 does not receive the indication, the UE 320 applies the constant circular shift to the subframe/slot number. In some cases, the value of SubframeShift or the SlotShift may be indicated explicitly within the RACH configuration message 330.

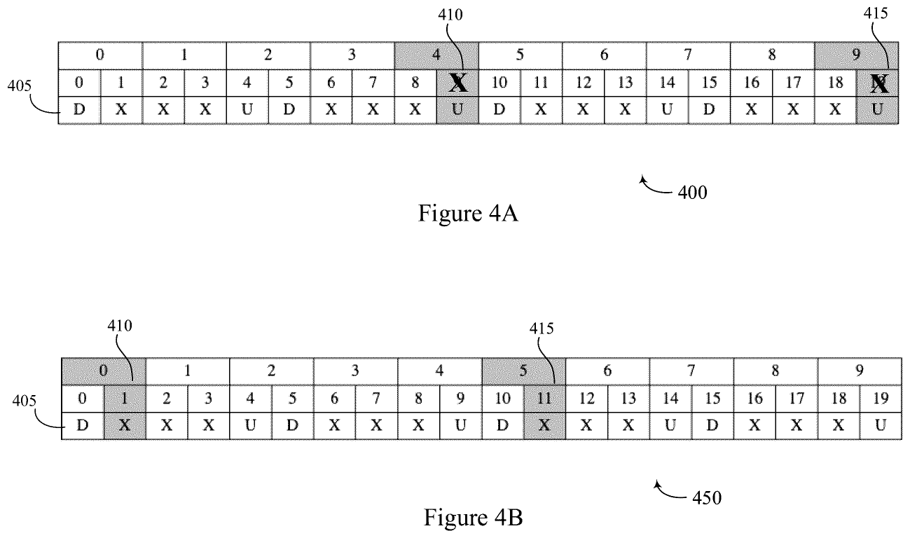

In some embodiments, when a RACH configuration is intended for SBFD slots/symbols, the ROs are valid the ROs satisfy one or more predefined ROs validation rules (e.g., the ROs fall within usable UL resource blocks). FIG. 4A-4B illustrate example RACH configurations in accordance with aspects of the present disclosure.

FIG. 4A depicts a first RACH configuration 400, such as RACH configuration #71, having subframe numbers (e.g., at SCS of 15 kHz) 0-9 and slot numbers 0-19 (e.g., at SCS of 30 kHz). Assuming a UE (e.g., the UE 32) is provided with an SBFD time-frequency pattern 405 of DXXXU, ROs 410 and 145 occur at slot #9 and slot #19, respectively (e.g., assuming an SCS of 30 KHz). When the RACH configuration #71 is intended for SBFD slots/symbols, the ROs 410, 415 are invalid (e.g., shown as an X), because the ROs fall within U slots (e.g., slot #9 and slot #19 are not SBFD X slots). However, with a derived RACH configuration 450, (e.g., a new RACH configuration #71) the ROs 410, 415 occur at slot #1 and slot #11, respectively. Thus, the ROs 410, 415 fall within usable UL RBs, as configured by the SBFD time-frequency pattern, and are considered to be valid ROs.

In some embodiments, the RACH configuration message 330 may indicate a bitmap that overrides and/or indicates subframes and/or slot numbers of an indicated PRACH configuration index. For example, to reduce overhead due to indicating the bitmap, the bitmap may include two or more parts, where each part indicates a group of subframes/slots that have ROs, with a final bitmap being formed as a Kronecker product between the bitmap parts.

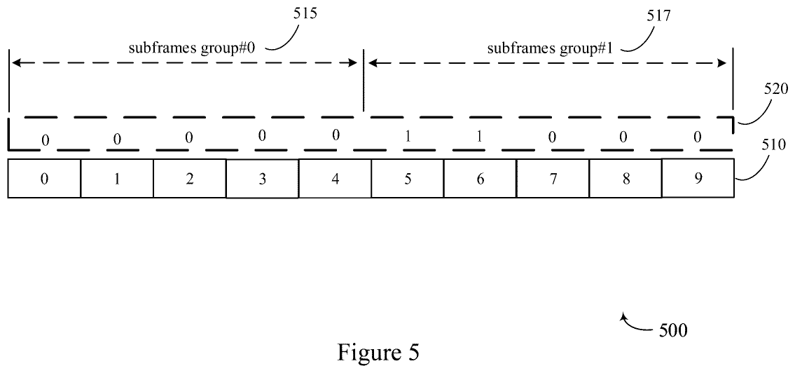

FIG. 5 illustrates an example mapping of a bitmap for a RACH configuration message (e.g., the RACH configuration message 330) in accordance with aspects of the present disclosure. A bitmap 520, mapped to subframe numbers 510 of a time resource, is a combination of a first subframes group 515 and a second subframes group 517. For example, the bitmap 520 may be a Kronecker product of a first bitmap (e.g., Bitmap 1={0 1}) and a second bitmap (e.g., Bitmap 2={11000}), as follows:

$$Final Bitmap = Bitmap 1 ⊗ Bitmap 2 = \{ 01 \} ⊗ \{ 11000 ] = \{ 0000011000 \} .$$

In some cases, if one or more parts of the bitmap are not indicated, the default bitmap is an all-ones bitmap with a predefined bit-length (e.g., {1 1 1 1 1 1}).

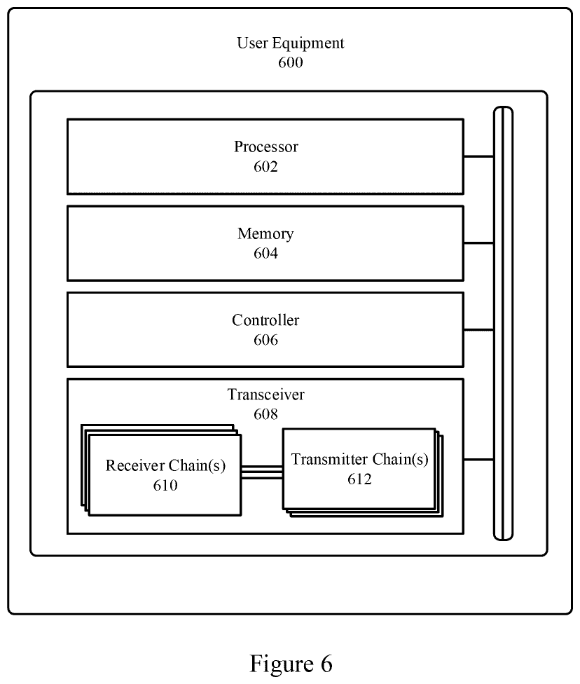

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein.

For example, the processor 602 may support wireless communication at the UE 600 in accordance with examples as disclosed herein. The UE 600 may be configured to support a means for receiving a RACH configuration message that indicates one or more PRACH configuration indexes, determining a PRACH configuration by combining a subframe or slot number from the one or more PRACH configuration indexes, and transmitting a PRACH preamble on an RO that is selected from the determined PRACH configuration.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 510, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

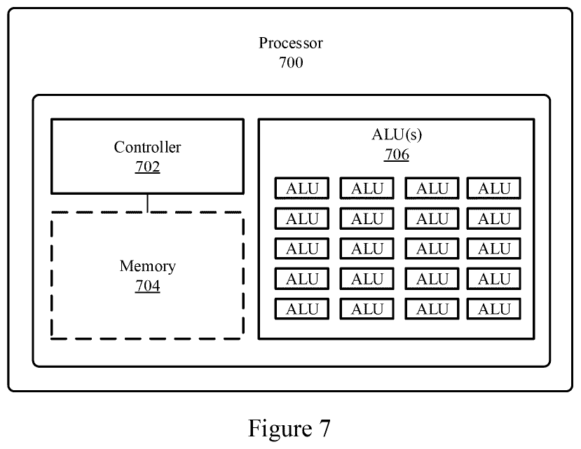

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. For example, the processor 700 may be configured to support a means for receiving a RACH configuration message that indicates one or more PRACH configuration indexes, determining a PRACH configuration by combining a subframe or slot number from the one or more PRACH configuration indexes, and transmitting a PRACH preamble on an RO that is selected from the determined PRACH configuration.

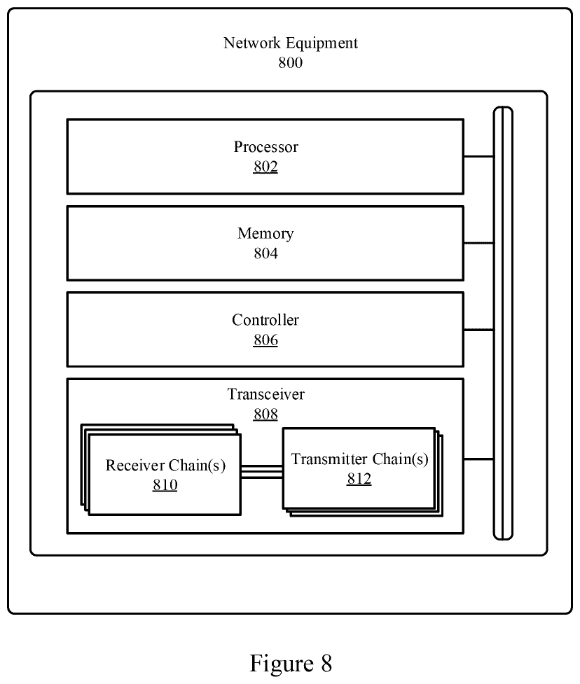

FIG. 8 illustrates an example of a NE 800 in accordance with aspects of the present disclosure. The NE 800 may include a processor 702, a memory 704, a controller 706, and a transceiver 808. The processor 802, the memory 704, the controller 706, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for generating a RACH configuration message that indicates two or more PRACH configuration indexes and transmitting the RACH configuration message to a UE.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

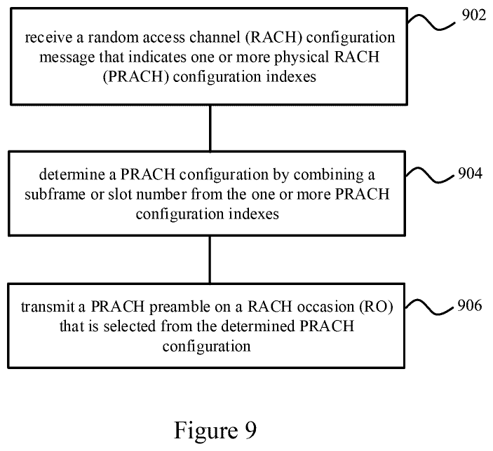

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving a RACH configuration message that indicates one or more PRACH configuration indexes. The operations of 902 may be performed in accordance with examples as described herein. In some implementations, aspects of the operations of 902 may be performed by a UE as described with reference to FIG. 6.

At 904, the method may include determining a PRACH configuration by combining a subframe or slot number from the one or more PRACH configuration indexes. The operations of 904 may be performed in accordance with examples as described herein. In some implementations, aspects of the operations of 904 may be performed by a UE as described with reference to FIG. 6.

At 906, the method may include transmitting a PRACH preamble on an RO that is selected from the determined PRACH configuration. The operations of 906 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

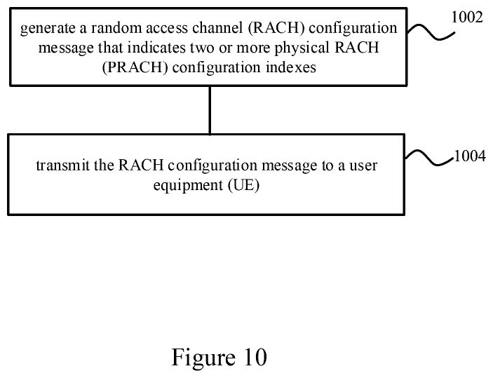

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include generating a RACH configuration message that indicates two or more PRACH configuration indexes. The operations of 1002 may be performed in accordance with examples as described herein. In some implementations, aspects of the operations of 1002 may be performed by an NE as described with reference to FIG. 8.

At 1004, the method may include and transmitting the RACH configuration message to a UE. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a random access channel (RACH) configuration message that indicates one or more physical RACH (PRACH) configuration indexes;
determine a PRACH configuration by combining a subframe or slot number from the one or more PRACH configuration indexes; and
transmit a PRACH preamble on a RACH occasion (RO) that is selected from the determined PRACH configuration.

2. The UE of claim 1, wherein the one or more PRACH configuration indexes are associated with a symbol type, including a subband full duplex (SBFD) symbols type and a non-SBFD symbols type.

3. The UE of claim 1, wherein the RACH configuration message indicates at least one PRACH configuration index for each symbol type, and wherein the at least one processor is further configured to cause the UE to receive an indication to utilize a PRACH configuration index of a first symbol type when determining a PRACH configuration for a second symbol type.

4. The UE of claim 1, wherein the at least one processor is further configured to cause the UE to:
derive one or more values of the determined PRACH configuration by comparing values of the one or more PRACH configuration indexes.

5. The UE of claim 1, wherein the one or more PRACH configuration indexes includes:
a first PRACH configuration index that identifies a group of PRACH configurations separately indexed within a table; and
a second PRACH configuration index indicated from the group of PRACH configurations.

6. The UE of claim 1, wherein the at least one processor is configured to cause the UE to determine the PRACH configuration by applying a subframe circular shift or a slot circular shift to a subframe or slot number of a PRACH configuration indicated from the one or more PRACH configuration indexes.

7. The UE of claim 6, wherein the applied subframe circular shift or slot circular shift is fixed for each frequency range.

8. The UE of claim 1, wherein the RACH configuration message comprises a bitmap that indicates subframes or slot numbers of a PRACH configuration index of the one or more PRACH configuration indexes.

9. The UE of claim 1, wherein the bitmap is formed as a Kronecker product of multiple parts of the bitmap, and wherein each part of the multiple parts indicates a group of subframes or slot numbers.

10. A network entity for wireless communication, comprising:
at least one memory; and
at least one processor coupled with the at least one memory and configured to cause the network entity to:
generate a random access channel (RACH) configuration message that indicates two or more physical RACH (PRACH) configuration indexes; and
transmit the RACH configuration message to a user equipment (UE).

11. The network entity of claim 10, wherein the at least one processor is further configured to cause the network entity to:
receive a PRACH preamble on a RACH occasion (RO) associated with a PRACH configuration derived from the two or more RACH configuration indexes.

12. The network entity of claim 10, wherein the at least one processor is configured to cause the network entity to transmit the RACH configuration message via system information block type 1 (SIB1) signaling.

13. The network entity of claim 10, wherein the at least one processor is configured to cause the network entity to transmit the RACH configuration message via radio resource control (RRC) signaling or downlink control information (DCI) signaling.

14. The network entity of claim 10, wherein the RACH configuration message indicates at least one PRACH configuration index for each symbol type.

15. The network entity of claim 10, wherein the RACH configuration message comprises a bitmap that indicates subframes or slot numbers of a PRACH configuration index of the one or more PRACH configuration indexes.

16. The network entity of claim 15, wherein the bitmap is formed a Kronecker product of multiple parts of the bitmap, and wherein each part of the multiple parts indicates a group of subframes or slot numbers.

17. The network entity of claim 10, wherein the one or more PRACH configuration indexes are for a symbol type and include subband full duplex (SBFD) symbols and non-SBFD symbols.

18. The network entity of claim 10, wherein the at least one processor is further configured to cause the network entity to:
transmit a message that activates PRACH configuration indicated by the two or more PRACH configuration indexes.

19. A processor for wireless communication, comprising:
at least one controller coupled with at least one memory and configured to cause the processor to:
receive a random access channel (RACH) configuration message that indicates one or more physical RACH (PRACH) configuration indexes;
determine a PRACH configuration by combining a subframe or slot number from the one or more PRACH configuration indexes; and
transmit a PRACH preamble on a RACH occasion (RO) that is selected from the determined PRACH configuration.

20. A method performed by a network entity, the method comprising:
generating a random access channel (RACH) configuration message that indicates two or more physical RACH (PRACH) configuration indexes;
transmitting the RACH configuration message to a user equipment (UE).
